(19) United States
(12) Patent Application Publication
(10) Pub. No.: US 2005/0066228 A1
(43) Pub. Date: Mar. 24, 2005

(54) ERROR COMPENSATION METHOD AND APPARATUS FOR OPTICAL DISK DRIVE

(75) Inventors: Hui-Min Lai, Kaohsiung City (TW); Shun-Yung Wang, Chu-Pei City (TW); Fu-Shan Wang, Tai-Nan City (TW)

Correspondence Address: CONNOLLY BOVE LODGE & HUTZ LLP, SUITE 800, 1990 M STREET NW, WASHINGTON, DC, 20036-3425, US

(73) Assignee: MEDIATEK INC., Hsinchu City (TW)

(21) Appl. No.: 10/710,950

(22) Filed: Aug. 13, 2004

(30) Foreign Application Priority Data
Sep. 24, 2003 (TW) 092126398

(51) Int. Cl. G06F 11/00

(52) U.S. Cl. 714/8

(57) ABSTRACT

An error compensation method and apparatus for an optical disk drive is disclosed, in which the error compensation method comprises the following procedures. First, an error signal showing the deviation of a focal point of the optical disk drive from a track is detected, and an error signal between the sledge and the actuator may also be detected, so as to produce the first sledge driving signal. Secondly, the error signal of the focal point deviating from the track, the error signal between the sledge and the actuator, the first sledge driving signal or their combination is/are selected as the basis for the sledge compensation, and the second sledge driving signal is generated according to the magnitude(s) of the selected signal(s). Subsequently, the second sledge driving signal is intermittently used for driving the sledge for error compensation.

### BACKGROUND OF THE INVENTION

1. Field of the Invention

The present invention is related to an error compensation method and apparatus for an optical disk drive. More particularly, the invention is related to a positional error compensation method and apparatus for the actuator and the sledge of an optical disk drive.

2. Description of the Related Art

The sledge and actuator of an optical disk drive are used for coarse adjustment and fine adjustment for an optical pickup head of the optical disk drive, respectively. Because of processing deviation, degradation of material or temperature change, the relative components or the lead screw operative for driving the sledge may affect the moving characteristics of the sledge. For example, the sledge has different static friction forces in different places and along different moving directions, i.e., the sledge requires different forces for being driven from stationary to start moving, so as to overcome the static friction forces. When the optical disk drive runs in a relatively slow speed, it is easily in a state that the sledge has not yet overcome the static friction force to start moving; however, the movement of the actuator for pushing the optical pickup head already exceeds the limit of the optical pickup head, inducing the problem that the track-locking signal is out of control.

Because of the affection of the above-described static friction force, the driving voltage for the error compensation and the error between the sledge and the actuator are not in simple linear correlation. Accordingly, the actual voltage for driving the sledge may be too large or insufficient, so the accuracy of the compensation is somewhat influenced.

### SUMMARY OF THE INVENTION

The objective of the present invention is to provide an error compensation method and apparatus for an optical disk drive for generating a driving signal of the sledge based on an error signal or a driving signal through gain or empirical function, with a view to adjusting the error between the sledge and the actuator to gradually approach zero.

To accomplish the above-described objective, the present invention discloses an error compensation method of an optical disk drive. First, an error signal showing the deviation of a focal point from a track in the optical disk drive is detected, and an error signal between the sledge and the actuator of the optical disk drive may also be detected, so as to produce a first sledge driving signal. Secondly, the above-described error signals, the first sledge driving signal or their combination is/are selected as the basis for the sledge compensation, and a second sledge driving signal is generated based on the magnitude(s) of the selected signal(s). Subsequently, the second sledge driving signal is intermittently used for driving the sledge for error compensation.

The above-described error compensation method for an optical disk drive can be implemented by an error compensation apparatus, which includes a photo detector integrated circuit (PDIC), a signal generator, a servo controller and a microprocessor. The PDIC is used for detecting a reflection signal of the optical pickup head of the optical disk drive. The signal generator generates at least one error signal based on the reflection signal to reflect the error of the optical disk drive's focal point deviating from a track or the error between the actuator and the sledge. The servo controller generates the first sledge driving signal based on the error signal showing the deviation of the focal point from the track. The microprocessor generates the second sledge driving signal based on the signal(s) selected from the group of the error signals, the first sledge driving signal and their combination to intermittently drive the sledge.

The error compensation method and apparatus for an optical disk drive in accordance with the present invention use intermittent compensation, i.e., through the step-by-step adjustment, to achieve a more precise compensation value. In addition, the error signal or the first sledge driving signal can be preset to the same voltage of the second sledge driving signal according to the empirical value in segments to reflect the actually required driving force, so as to avoid the interference of the static friction force to the accuracy of the compensation.

### BRIEF DESCRIPTION OF THE DRAWINGS

FIG. 1 exemplifies an error compensation apparatus for an optical disk drive in accordance with the present invention; and

FIGS. 2 and 3 illustrate the operation of the error compensation method of an optical disk drive in accordance with the present invention.

### DETAILED DESCRIPTION OF THE INVENTION

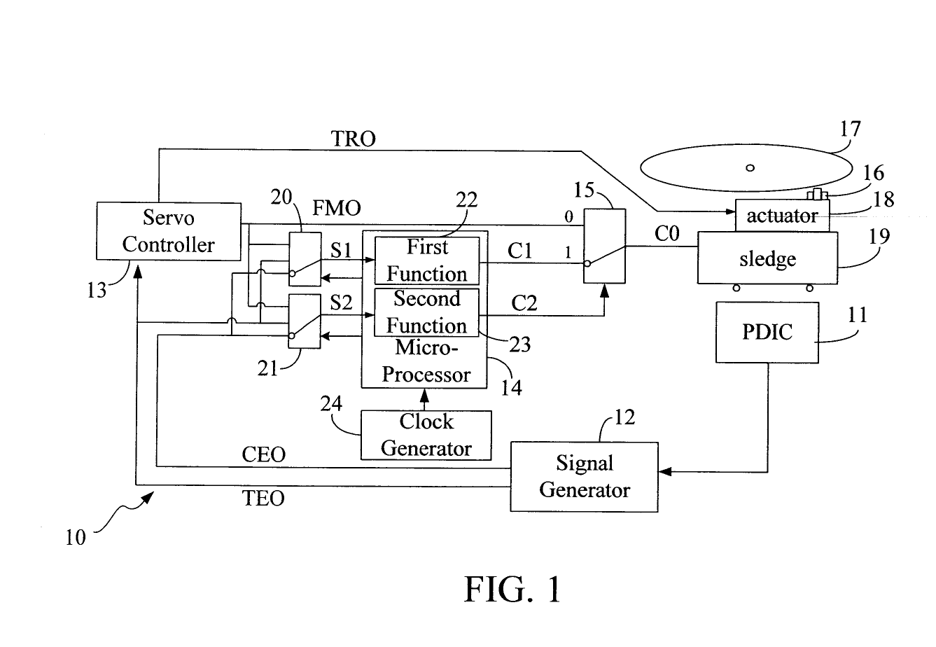

Referring to FIG. 1, which is the illustrative diagram of an error compensation apparatus 10 for an optical disk drive in accordance with the present invention, the error compensation apparatus 10 includes a PDIC 11, a signal generator 12, a servo controller 13, a microprocessor 14, a clock generator 24 and switches 15, 20 and 21. An optical pickup head 16 emits a light onto an optical disk 17, and the PDIC 11 can detect an optical reflection signal from the optical disk 17. Then, the optical reflection signal is transmitted to the signal generator 12 to generate error signals TEO and CEO, in which the TEO reflects the error of the focal point deviating from a track, and the CEO reflects the positional error between the actuator 18 and the sledge 19 of the optical disk drive. The error signal TEO is transmitted to the servo controller 13 to generate a first sledge driving signal FMO and an actuator driving signal TRO, so as to drive the sledge 19 and the actuator 18, respectively. The sledge 19 and the actuator 18 are used for coarse adjustment and fine adjustment for the optical pickup head 16, respectively.

The microprocessor 14 can select the error signals TEO, CEO, the first sledge driving signal FMO or their combination for processing, in which a first function 22 can be executed to generate a second sledge driving signal C1 based on the magnitude(s) of the selected signal(s). In addition, a second function 23 incorporated in the microprocessor 14 can be executed based on the signal(s) selected from the group of the error signals TEO, CEO, the first sledge driving signal FMO and their combination, while the selected one(s) may be not the same as the signal(s) selected by the first function 22, so as to output a control signal C2 for controlling the switch 15, thereby the switching of the first and the second sledge driving signals FMO and C1 is under control.

The output signal CO (i.e., FMO or C1) of the switch 15 is used for driving the sledge 19. For the convenience of following descriptions, the above-described selected signals input to the microprocessor 14 for the executions of the first function 22 and the second function 23 are denoted by S1 and S2, respectively, in which the S1 and S2 may represent multiple signals or a single signal individually. The switches 20 and 21 are connected to the input ends of the microprocessor 14, so as to select the signals selected by the first function 22 and the second function 23 as the S1 and S2 signals. The signals S1 and S2 can be selected according to empirical values. The switches 15, 20 and 21 are controlled by the microprocessor 14.

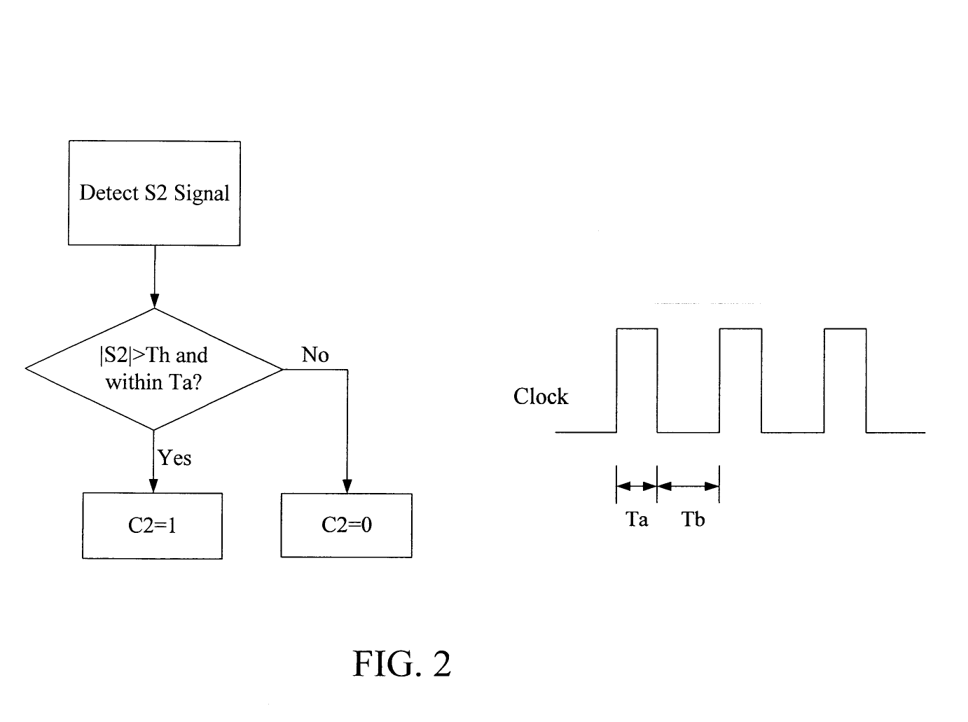

FIG. 2 illustrates the operation of a preferred embodiment of the second function 23. The right part of FIG. 2 shows a clock signal generated by the clock generator 24, and the time period at high level is denoted by Ta, whereas the time period at low level is denoted by Tb. If the absolute value of the detected signal S2, i.e., |S2|, is larger than a preset threshold value Th and is located in the time period of Ta, the output control signal C2 is 1, thereby the switch 15 is switched to the path connecting the second sledge driving signal C1. Otherwise, if the control signal C2 is 0, the switch 15 is switched to the path connecting the first sledge driving signal FMO. If |S2|>Th, the output signal C0 of the switch 15 in the time at high level Ta and low level Tb equals to C1 and FMO, respectively, i.e., the switching is repeated between them. The threshold value Th is used for filtering out noises, so as to avoid unnecessary error compensation. In this embodiment, the second sledge driving signal C1 is sent out when the clock signal is at high level Ta. Nevertheless, the C1 can be sent out in the time at low level Tb, and the intermittent output effect can also be achieved.

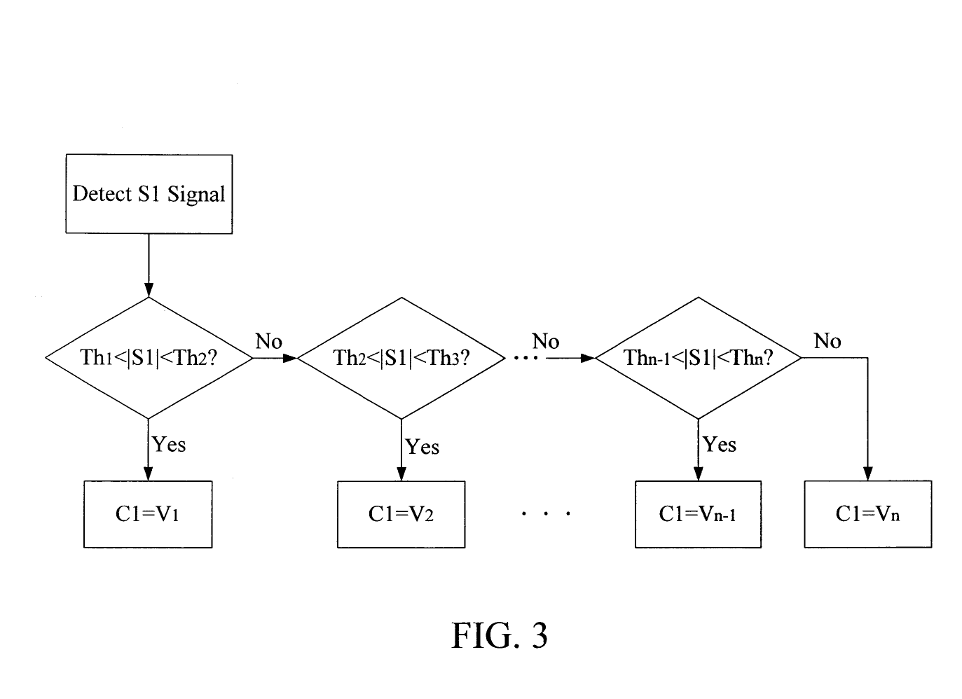

FIG. 3 illustrates the operation of a preferred embodiment of the first function 22. First, multiple threshold values Th1, Th2, Th3 . . . Thn are preset. If the absolute value of the detected signal S1 is between Th1 and Th2, the voltage of the second output sledge driving signal C1 equals to V1, otherwise it is to be further determined whether it is between Th2 and Th3. If the absolute value of the signal S1 is between Th2 and Th3, the voltage of C1 equals to V2. Likewise, if the absolute value of the signal S1 is between Thn-1 and Thn, the voltage of C1 equals to Vn-1, otherwise the voltage of C1 equals to Vn. In this embodiment, the output voltage V1, V2 . . . Vn-1 and Vn increases gradually, i.e., V1<V2< . . . <Vn-1<Vn. As regards the meaning in physics, the bigger the detected error signal or driving signal is, the bigger the error between the sledge 19 and the actuator 18 is. Therefore, a relatively larger error compensation voltage should be selected from the preset voltage V1, V2 . . . Vn-1 and Vn to drive the sledge 19 for compensation.

The preset threshold value Th, Th1, Th2, Th3 . . . Thn of the first and second function 22, 23 in FIG. 2 and FIG. 3 can be set according to the experience of designer, with a view to achieving the most accurate compensation. Through the control of the second function 23, the second sledge driving signal C1 can be intermittently output for driving the sledge 19 to proceed the correction step-by-step. The segmental setting of the first function 22 based on the empirical value can output actually required driving voltage, so as to overcome the influence of the static friction force.

In addition, the sledges or the actuators of the same type may still have micro variations occurring in the manufacturing process of the optical disk drive, inducing various errors between the sledges and actuators. Nevertheless, by the way put forth in the present invention, the variation of the product itself can be overcome.

In practice, the error compensation method and apparatus for an optical disk drive of the present invention are not limited to use the above-described first and second functions 22, 23, but can be replaced by an arithmetic algorithm deduced by the empirical values or a gain circuit.

The above-described embodiments of the present invention are intended to be illustrative only. Numerous alternative embodiments may be devised by those skilled in the art without departing from the scope of the following claims.

1. An error compensation method for an optical disk drive, comprising the steps of:
detecting an error signal showing the deviation of a focal point from a track of the optical disk drive;
generating a first sledge driving signal based on the error signal showing the deviation of the focal point;
generating a second sledge driving signal based on the magnitude of the error signal or the first sledge driving signal; and
intermittently driving a sledge of the optical disk drive by the second sledge driving signal to perform error compensation.

2. The error compensation method for an optical disk drive in accordance with claim 1, further comprising the step of detecting error signals between an actuator and the sledge of the optical disk drive.

3. The error compensation method for an optical disk drive in accordance with claim 1, wherein the first and second sledge driving signals alternately drive the sledge of the optical disk drive for error compensation.

4. The error compensation method for an optical disk drive in accordance with claim 1, wherein the second sledge driving signal is employed to drive the sledge of the optical disk drive when a clock signal is at high level.

5. The error compensation method for an optical disk drive in accordance with claim 1, further comprising the step of filtering the error signal smaller than a preset threshold value.

6. The error compensation method for an optical disk drive in accordance with claim 1, wherein the magnitude of the second sledge driving signal is proportional to that of the error signal or the first sledge driving signal.

7. The error compensation method for an optical disk drive in accordance with claim 1, further comprising the step of dividing the error signal or the first sledge driving signal into segments based on magnitude thereof, wherein the second sledge driving signal generated from the error signal or the first sledge driving signal in the same segment has the same voltage.

8. An error compensation apparatus for an optical disk drive, comprising:
a photo detection integrated circuit for detecting a reflection signal of an optical pickup head of the optical disk drive;
a signal generator for generating at least one error signal based on the reflection signal, wherein the at least one error signal comprises an error signal showing the deviation of a focal point from a track of the optical disk drive;
a servo controller for generating a first sledge driving signal based on the error signal showing the deviation of the focal point; and
a microprocessor for generating a second sledge driving signal based on the magnitude(s) of the signal(s) selected from the group of the first sledge driving signal and the error signal and for controlling the second sledge driving signal to intermittently drive a sledge of the optical disk drive.

9. The error compensation apparatus for an optical disk drive in accordance with claim 8, further comprising a clock generator for generating a clock signal, wherein the microprocessor outputs the second sledge driving signal when the clock signal is at high level.

10. The error compensation apparatus for an optical disk drive in accordance with claim 8, further comprising a switch for intermittently transmitting the second sledge driving signal to the sledge of the optical disk drive.

11. The error compensation apparatus for an optical disk drive in accordance with claim 8, wherein the error signal further comprises an error signal between an actuator and the sledge of the optical disk drive.
